(19) United States
(12) Patent Application Publication
(10) Pub. No.: US 2018/0218826 A1
(43) Pub. Date: Aug. 2, 2018

(54) MAGNETIC CORE, AND CHOKE OR TRANSFORMER HAVING SUCH A MAGNETIC CORE

(71) Applicant: James MILLSAP, Freising (DE)

(72) Inventor: James MILLSAP, Freising (DE)

(21) Appl. No.: 15/742,904

(22) PCT Filed: Jul. 10, 2015
(86) PCT No.: PCT/EP2015/065903

§ 371 Date: Jan. 9, 2018

(51) Int. Cl. H01F 27/26; H01F 30/12; H01F 3/06; H01F 3/14

(52) U.S. Cl. CPC H01F 27/263; H01F 30/12; H01F 2003/106; H01F 3/14; H01F 3/06

(57) ABSTRACT

The invention relates to a magnetic core (10) for a three-phase choke or a three-phase transformer, comprising three winding legs (11, 12, 13) for holding electrical windings (21, 22, 23), wherein the winding legs (11, 12, 13) are arranged substantially parallel to each other in the shape of a triangle, wherein the winding legs (11, 12, 13) are connected by means of an annular or convex polygonal yoke (14), which lies on the winding legs (11, 12, 13). The invention also relates to a choke or transformer having such a magnetic core (10).

The invention relates to a magnetic core for a three-phase choke or a three-phase transformer according to the preamble of claim 1. The invention also relates to a three-phase choke or a three-phase transformer having such a magnetic core. A magnetic core in accordance with the preamble of patent claim 1 is known, for example, from DE 10 2012 207 557 A1.

The previously known magnetic core has three magnetic legs, each of which are adapted for holding a first, second, or third electrical winding. The first, second, and third electrical winding are assigned in each case to a first, second and third electrical phase. In order to compensate for asymmetries of the three-phase system, the three magnetic legs are arranged in a star-shaped or triangular configuration with respect to each other. This is claimed to be more advantageous than the widespread serial arrangement of the legs commonly used previously.

The three legs of the known choke are connected to each other by a yoke, which has a star-shaped configuration. In particular, the yoke has a central point, from which three magnetic connecting legs extend radially outward. In this way, the three legs are coupled to each other in a star configuration.

The star-shaped design of the yoke has several disadvantages. Firstly, to mount the yoke on the legs requires an exact alignment of the connecting leg of the yoke before connecting the magnetic yoke to the legs. Secondly, the coils of the choke are largely exposed at their longitudinal axial ends, because the connecting legs only overlap a small area of the coils. Finally, the star-shaped design of the yoke has an adverse effect on the tilting stability of the choke. This is especially true if a plurality of identical chokes are to be stacked on top of one another. This again requires a prior alignment of the orientation of the star-shaped yokes to prevent tipping of the second choke that is placed on top of a first choke.

The object of the present invention is to provide a magnetic core that is simple to assemble, has an improved mechanical stability and/or provides good protection for windings of a choke or a transformer. A further object of the present invention is to specify a choke or transformer having such a magnetic core.

In accordance with the invention, this object is achieved in relation to the magnetic core by the subject matter of patent claim 1 and in relation to the choke or transformer by the subject matter of patent claim 14.

The invention is based on the idea of specifying a magnetic core for a three-phase choke or a three-phase transformer having three winding legs for holding electrical windings, wherein the winding legs are arranged substantially parallel to each other in the shape of a triangle. The winding legs are connected by an annular or convex polygonal yoke, which rests on the winding legs.

The arrangement of the winding legs in a triangular shape enables asymmetries, which occur for example in magnetic legs arranged in rows, to be avoided. The winding legs are arranged substantially parallel to each other, wherein the winding legs, in particular their longitudinal ends, define a triangular base form. In other words, in the cross-section of the magnetic core the three winding legs form the corners of a triangle.

The annular or convex polygonal yoke facilitates the production of the magnetic core. The advantage of the simplification applies mainly in the connection of the yoke to the winding legs.

When an annular yoke is used, alignment of the yoke with respect to the winding legs is no longer required. Instead, the annular yoke can be placed on the winding legs in any given orientation and thus connect them together.

The annular or convex polygonal yoke also increases the stability of the magnetic core. This is particularly true if a plurality of magnetic cores are to be stacked on top of one another. When stacking magnetic cores having an annular yoke, a comparatively large surface contact exists between the stacked yokes. This increases the tilting stability.

The use of a convex polygonal shape for the yoke also requires no alignment of multiple magnetic cores to avoid any risk of tilting. This is because, due to the polygonal shape any rotationally offset arrangement of opposite or stacked yokes can be avoided. Because of the polygon shape sufficiently large portions of the surface overlap each other, thus avoiding any tilting of the magnet cores. For example, this facilitates the installation of a plurality of magnetic cores in a housing.

In addition, the use of the annular or convex polygonal yoke enables a relatively larger proportion of the winding to be covered by the yoke in the longitudinal axial direction. In this respect, the yoke provides protection against damage for the windings of a choke that are wound around the winding legs. This is because the yoke forms a longitudinal axial barrier, so that a relatively greater proportion of the winding is not readily accessible.

In the context of the present application, a convex polygonal component is defined as one which has multiple vertices on at least one circumferential outer side, wherein all interior angles of the polygonal form are less than 180°. A regular polygonal component is defined as one which has multiple vertices on at least one circumferential outer side, and has equal side lengths and equal interior angles. The polygonal shape can in general be exhibited on more than one outer side. In fact, the yoke can also form a through-opening, which can also be polygonal in shape. In this case, the polygon shape on an outer side of the yoke can differ from the polygon shape inside, i.e. the polygonal shape of the through-opening. For example, the yoke as a whole, i.e. considering the outside, can be hexagonal in shape and can bound a triangular opening.

Preferably, the yoke rests on the longitudinal ends of the winding legs. This does not exclude the possibility of providing an air gap between the yoke and the longitudinal ends. In all cases, the essential point is that a magnetic flux can be maintained between the yoke and the winding leg.

In a preferred embodiment of the invention, the yoke has three cross-connecting legs, each cross-connecting leg connecting two directly adjacent winding legs. The cross-connecting legs can be designed arcuate in shape, in particular, circularly arcuate, or else straight in at least some sections. Preferably, the arcuate cross-connecting legs are curved in such a way that all three cross-connecting legs together form the annular yoke. In the case of straight cross-connecting legs it is advantageously provided that each two cross-connecting legs intersect in the region of a winding leg. In particular, each two cross-connecting legs intersect at longitudinal ends of the winding legs, or else on a circular arc on which all winding legs are arranged. In general, it can be provided that no intersection point of the cross-connection legs is provided in a region between the three winding legs.

The cross-connecting legs can extend up to a circumference line which is defined by the triangular arrangement of the winding legs. In the region of the internal area of the triangular shape that is defined by the winding legs, no connection preferably exists between the cross-connecting legs.

The direct coupling of two adjacent winding legs by in each case one cross-connecting leg also changes the magnetic flux within the magnetic core. This can have a positive effect on the function of a three-phase alternating current choke or a three-phase alternating current transformer. In particular, due to the geometric design of the yoke proposed in accordance with the invention, the magnetic currents do not meet at a centre of the yoke, but instead extend along the circumference line between the winding legs. This influences the functioning of the choke or transformer.

Specifically, in the magnetic core according to the invention it can be provided that a first cross-connecting leg connects a first and second winding leg to each other, a second cross-connecting leg connects a second and third winding leg to each other, and a third cross-connecting leg connects the third and first winding legs to each other. Preferably, each cross-connecting leg is connected to two winding legs. The individual cross-connecting legs can each only be connected to two winding legs and, if appropriate, two cross-connecting legs.

In general, the magnetic core has magnetically conductive properties. In this respect, the magnetic core is a passive component. The magnetic core does not form an active magnet.

The magnetic core can form a plurality of magnetic circuits. The magnetic flux within the magnetic core is then generated by induction. In particular, the first and the second winding legs can partially form a first magnetic circuit. A second magnetic circuit can comprise the second and third winding legs, and a third magnetic circuit can comprise the third and first winding legs. In all magnetic circuits, a magnetic field can be maintained, wherein the magnetic circuits essentially have a uniform flux length. It is also preferably provided that the magnetic circuits form the same magnetic resistance. This can be achieved by a uniform geometric structure and by using a common material for the magnetic core.

Specifically, the invention can provide that the yoke, and in particular the connecting legs, form a closed shaped element. The closed shaped element can have a through opening, which is preferably centrally positioned. Since essentially no magnetically conducting material is required in the centre of the yoke to produce an adequate level of magnetic flux within a choke or transformer, the use of the through-opening economizes on material, leading to a reduction in costs. Furthermore, the through-opening leads to a weight reduction of the magnetic core. Finally, the opening also provides ventilation for the magnetic core, or a choke or a transformer, so that overheating of the choke or transformer is avoided.

The yoke can generally be designed as a single part or from multiple parts. The integral production of the yoke promotes the homogeneity of the yoke, or of the magnetic core as a whole. The multi-part design of the yoke can lead to cost savings, since standardized magnetic core components can be used. These only need to be assembled and bonded together, for example.

The winding legs can also be designed from a single part or from multiple parts. In particular, good results can be achieved by using multi-part designs of the winding legs and/or of the yoke. A plurality of air gaps can be provided between the individual elements of the yoke or the winding legs. This “multi-gap” structure reduces the inductive losses and thereby improves the magnetic flux within the magnetic core.

In particular, the yoke and/or the winding legs can be formed by a compressed powder composite material. In particular, by using a powder composite material which is pressed into the desired shape, a single-part variant of the yoke can be easily produced. Alternatively, the powder composite material can also be used for producing individual components.

The powder composite material preferably comprises iron, nickel, silicon, aluminium and/or molybdenum. In concrete terms, it can be provided that the powder composite material, which is used to form the magnetic core, forms an alloy of nickel, iron and molybdenum or an alloy of iron and nickel or an alloy of iron, silicon and aluminium or an iron-silicon alloy, or other iron alloy. It is also possible for the magnetic core to use a ferrite material, an amorphous material and/or a nanocrystalline material.

The above-mentioned materials and material compounds have proved to be particularly suitable for producing a magnetic core. In particular, the magnetic properties of the magnetic core are improved through the use of these materials.

In a particularly preferred embodiment of the invention, the yoke is designed with a triangular or hexagonal shape. The triangular shape provides a high degree of compactness, since it only connects the longitudinal ends of the winding legs to each other. In the case of the hexagonal design of the yoke, sharp edges are avoided and the stackability of the magnetic core is increased.

In addition, the hexagonal yoke covers a larger proportion of the windings of the winding legs in the longitudinal axial direction of the magnetic core. The hexagonal shape of the yoke thus contributes to the protection of the windings of a choke or transformer.

In a further preferred variant of the invention, the winding legs have a circular or rectangular cross-sectional shape. In other words, the winding legs can have a circular-cylindrical or cuboidal design. The circular-cylindrical design of the winding legs is cost-effective due to the relatively low material and tooling costs. The use of a rectangular cross-section for the winding legs, on the other hand, improves the thermal properties of a choke or transformer. This is because winding a wire around a winding leg with a rectangular cross-section requires an increase in the spacing between two coils or windings around the winding leg. This in turn promotes the cooling of the windings, since the windings can thus be well ventilated with air.

The yoke can be adhesively bonded to the winding legs, in particular to the longitudinal ends of the winding legs. For the bonding, an adhesive is preferably used which is high-temperature resistant. The adhesive has a damping property, which cushions the vibrations between the yoke and the winding legs. The bonding itself is simple to implement and therefore facilitate the assembly of the magnetic core. This applies in particular to magnetic cores, which are built up from layers of magnetic sheet metal.

In a further preferred design of the invention, a discharge leg, which is connected to the yoke, is arranged centrally between the three winding legs. The discharge leg preferably extends parallel to the three winding legs. The discharge leg can conduct high-frequency alternating magnetic fields, for example, and thus dissipate asymmetrical components or submit them to further processing.

A subsidiary aspect of the invention relates to a three-phase choke or a three-phase transformer having a magnetic core as previously described. The three-phase choke or three-phase transformer also have at least one electrical winding, which is wound around one of the winding legs. Preferably, three electrical windings are provided, wherein one electrical winding is associated with each winding leg of the magnetic core. Each individual electrical winding is preferably assigned one phase of the three-phase alternating current.

In a preferred design of the choke according to the invention or transformer according to the invention it can be provided that the winding is formed by a flat wire, in particular a flat enamelled copper wire. The use of a flat wire is particularly suitable for low frequencies of the alternating current. The flat wire is also characterized by a high mechanical stability. Finally, the use of a flat wire also leads to a compact overall design of the choke or transformer. In particular, a reduction in the overall size can be achieved in the longitudinal axial length of the choke or transformer.

Instead of a flat wire, a round wire can also be used. Other suitable materials can also be provided for the windings, such as copper foil (Cu foil), HF stranded wires or a combination of these with flat wire or round wire. For example, an HF stranded wire can be combined with a flat wire.

The invention is described in greater detail in the following by reference to the attached schematic drawings. They show:

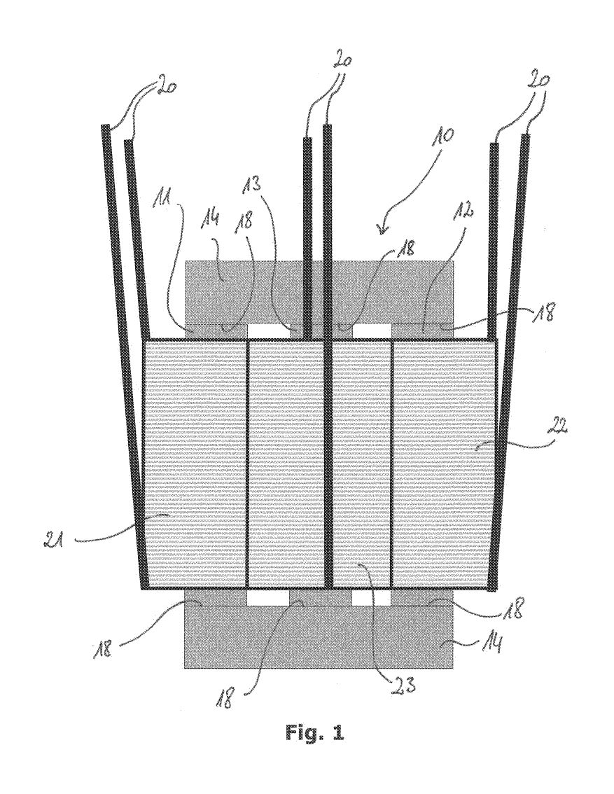

FIG. 1: a side view of a choke according to the invention or a transformer according to a preferred exemplary embodiment;

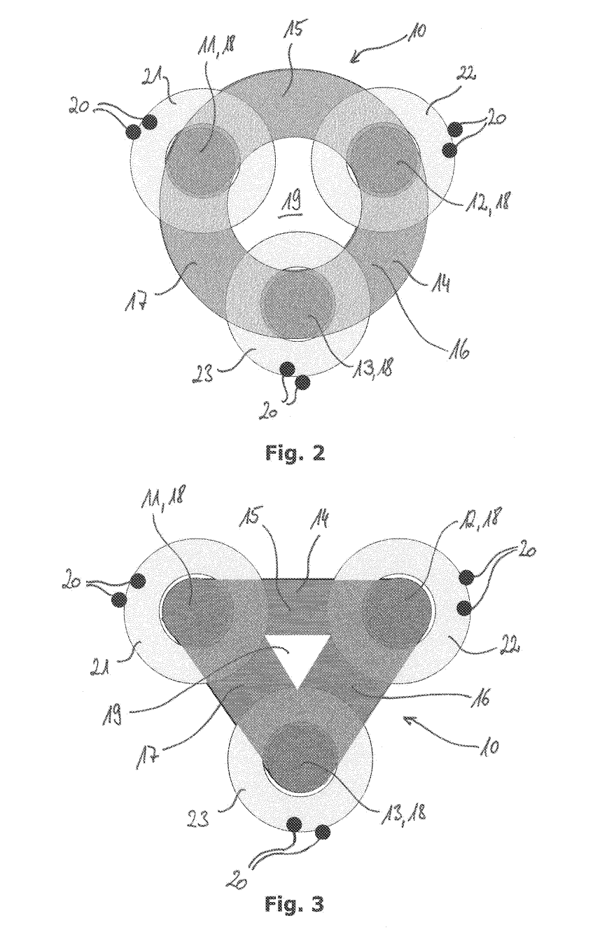

FIG. 2: a plan view of the choke or the transformer in accordance with FIG. 1; and

FIG. 3: a plan view of an alternative choke or an alternative transformer according to a preferred exemplary embodiment.

FIG. 1 shows a three-phase choke or a three-phase alternating current choke in a side view. The choke comprises a magnetic core 10 with three winding legs 11, 12, 13. The three winding legs 11, 12, 13 are arranged substantially parallel to each other, or extend parallel to a longitudinal axis of the choke. At their longitudinal ends 18 the winding legs 11, 12, 13, are each connected to a yoke 14. The yoke 14 couples the three winding legs 11, 12, 13 to each other magnetically. The yoke 14 can also be adhesively bonded to the winding legs 11, 12, 13.

In general, the winding legs 11, 12, 13 and the yoke 14 can be produced from a powder composite material. The magnetic core overall is in that case implemented as a powder core. The use of a powder core material has the advantage that during the production of the magnetic core 10 microscopic air gaps are formed within the magnetic core 10, which are advantageous for the magnetic permeability. It is generally advantageous for a uniform magnetic flux or a uniform magnetic resistance if the yoke 14 and the winding legs 11, 12, 13 are made from the same material.

In one embodiment, not shown here, it can be provided that a fourth winding leg is arranged centrally between the three winding legs 11, 12, 13 as a discharge leg. The fourth winding legs can have a ferrite core and be suitable for conducting a magnetic field that can be produced due to asymmetries in the three-phase system.

In particular, the fourth discharge leg can be made smaller than the three winding legs 11, 12, 13 and conduct asymmetrical harmonic components. In the fourth discharge leg, high-frequency alternating magnetic fields are produced, which leads to an improvement in the symmetry of a three-phase choke. The same applies to a three-phase transformer, which differs from the three-phase choke only in the fact that additional windings are applied to the winding legs 11, 12, 13.

As is additionally shown in FIG. 1, the yoke 14 and the winding legs 11, 12, 13 have substantially the same thickness. This also achieves an improvement of the magnetic flux while simultaneously reducing the material used.

The three winding legs 11, 12, 13 comprise a first winding leg 11, a second winding leg 12 and a third winding leg 13. The first winding leg 11 carries a first winding 21. The second winding leg 12 carries a second winding 22. The third winding leg 13 carries a third winding 23. The windings 21, 22, 23 can have the same design. The windings 21, 22, 23 are preferably formed by a copper wire, in particular an enamelled copper wire.

It is particularly advantageous to use a flat wire or a flattened enamelled copper wire. This means that for an increased conductor cross-section capable of carrying correspondingly high currents, the total assembled size of the choke can be reduced. In particular, the height of the windings 21, 22, 23 can be reduced in this way, while high currents can still be carried.

The individual windings 21, 22, 23 each have two winding connections 20 that are used for the electrical connection of the windings 21, 22, 23. It is preferred if each of the windings 21, 22, 23 is assigned to different phases of a three-phase system. Thus the first winding 21 can be assigned to a first electrical phase L1, the second winding 22 to a second electrical phase L2, and the third winding 23 to a third electrical phase L3.

FIGS. 2 and 3 show two different exemplary embodiments of a choke, which differ from each other in the geometrical form of the yoke 14. The side view according to FIG. 1 applies to both exemplary embodiments in accordance with FIGS. 2 and 3.

In FIG. 2, it is apparent that the yoke 14 is annular. The magnetic core 10 therefore comprises an annular yoke 14. The annular yoke 14 has a through-opening 19, which is circular in design. The width of the annular yoke 14 substantially corresponds to the diameter of the winding legs 11, 12, 13. The yoke 14 thus rests with its full surface on the winding legs 11, 12, 13, in particular on their longitudinal ends 18.

In concrete terms, the yoke 14 comprises three cross-connecting legs 15, 16, 17, each of which is arcuate in shape. A first cross-connecting leg 15 connects the first and second winding legs 11, 12 to each other. A second cross-connecting leg 16 connects the second winding leg 12 to the third winding leg 13. The third winding leg 13 and the first winding leg 11 are magnetically coupled by a third cross-connecting leg 17 of the yoke 14.

As is also clearly apparent from FIG. 2, the yoke 14 and the end faces of the windings 21, 22, 23 have comparatively large overlap regions.

The yoke 14 thus covers a relatively large proportion of the windings 21, 22, 23 and offers protection against damage in the longitudinal axial direction. In addition, the yoke 14 extends as far as the outer edge of the choke as a whole and thus also acts as a stop in a radial direction relative to a central longitudinal axis of the choke.

FIG. 3 shows an alternative design of the yoke 14, wherein the yoke forms a polygonal shape. Specifically, the choke shown in FIG. 3 is equipped with a triangular yoke 14, which has a triangular through-opening 19. The triangular yoke 14 also has three cross-connecting legs 15, 16, 17, which each connect the first, second and third winding legs 11, 12, 13 to each other. The cross-connecting legs 15, 16, 17 extend in a straight line between two adjacent winding legs 11, 12, 13. An intersection or junction of the cross-connecting legs 15, 16, 17 takes place at each of the longitudinal ends 18 of the winding legs 11, 12, 13.

It is also apparent in FIG. 3 that the triangular design of the yoke 14 gives rise to a relatively large region of overlap between the yoke surface and the end face of the windings 21, 22, 23. In this respect, the yoke 14 according to FIG. 3 also offers increased protection against damage to the windings 21, 22, 23. Also, the cross-connecting legs 15, 16, 17 preferably have a width which is equal to the diameter of the winding legs 11, 12, 13. This facilitates a good magnetic flux and also reduces the material costs for the magnetic core 10.

In FIGS. 2 and 3 the winding legs 11, 12, 13 are each designed as rounded core legs. However, it is also possible to provide the winding legs 11, 12, 13 with a rectangular cross-sectional geometry. The width of the yoke 14, and in particular of the cross-connecting legs 15, 16, 17, must then be adapted accordingly.

As is evident in the two exemplary embodiments in accordance with FIGS. 2 and 3, the annular or convex polygonal yoke 14 offers an improved footprint for the choke. In particular, the selected geometry facilitates the stackability of a plurality of magnetic cores 10 of chokes or transformers, which are fitted with the magnetic core 10. In addition, it is apparent that the triangular-shaped arrangement of the winding legs 11, 12, 13 leads to a compact design of the choke overall. At the same time, by using appropriate spacing distances between the individual winding legs 11, 12, 13 an improved cooling of a choke or transformer can be achieved. This is also promoted by the through-opening 19 in the yoke 14. A further contribution to the cooling of the choke or the transformer is provided by the nature of the windings 21, 22, 23. The windings 21, 22, 23 are preferably formed by a flat wire, which also improves the cooling with an appropriate winding interval. The choke or transformer therefore has a better performance overall.

The triangular-shaped yoke 14 preferably forms an isosceles triangle, particularly preferably an equilateral triangle. This enables a particularly compact design. In addition, the stackability of the magnetic core 10 is also improved. In the equilateral design of the triangular yoke 14, the cross-connecting legs 15, 16, 17 are arranged at an angle of 60° to one another.

### LIST OF REFERENCE NUMERALS

10 magnetic core
11 first winding leg
12 second winding leg
13 third winding leg
14 yoke
15 first cross-connecting leg
16 second cross-connecting leg
17 third cross-connecting leg
18 longitudinal end
19 through-opening
20 winding connection
21 first winding
22 second winding
23 third winding

1. Magnetic core (10) for a three-phase choke or a three-phase transformer having three winding legs (11, 12, 13) for holding electrical windings (21, 22, 23), wherein the winding legs (11, 12, 13) are arranged substantially parallel to each other in the shape of a triangle,
characterized in that
the winding legs (11, 12, 13) are connected by an annular or convex polygonal yoke (14), which rests on the winding legs (11, 12, 13).

2. Magnetic core(10) according to claim 1,
characterized in that
the yoke (14) rests on the longitudinal ends of the winding legs (11, 12, 13).

3. Magnetic core (10) according to claim 1 or 2,
characterized in that
the yoke (14) has three cross-connecting legs (15, 16, 17), each cross-connecting leg (15, 16, 17) connecting two directly adjacent winding legs (11, 12, 13).

4. Magnetic core (10) according to claim 3,
characterized in that
a first cross-connecting leg (15) connects a first and second winding leg (11, 12) to each other, a second cross-connecting legs (16) connects a second and third winding leg (12, 13) to each other, and a third cross-connecting leg (17) connects the third and first winding legs (13, 11) to each other.

5. Magnetic core (10) according to any one of the preceding claims,
characterized in that
the yoke (14), in particular the cross-connecting legs (15, 16, 17), form a closed shaped element having a preferably centrally arranged through opening (19).

6. Magnetic core (10) according to any one of the preceding claims,
characterized in that
the yoke (14) is formed from a single part or multiple parts.

7. Magnetic core (10) according to any one of the preceding claims,
characterized in that
the yoke (14) and/or the winding legs (11, 12, 13) are formed by a compressed powder composite material.

8. Magnetic core (10) according to claim 7,
characterized in that
the powder composite material comprises iron, nickel, silicon, aluminium and/or molybdenum.

9. Magnetic core (10) according to any one of the preceding claims,
characterized in that
the yoke (14) is in the shape of a triangle or hexagon.

10. Magnetic core (10) according to any one of the preceding claims,
characterized in that
the yoke (14) has an equilateral and/or equal-angled design, in particular, having the form of a regular polygon.

11. Magnetic core (10) according to any one of the preceding claims,
characterized in that
the winding legs (11, 12, 13) have a circular or rectangular cross-section.

12. Magnetic core (10) according to any one of the
preceding claims,
characterized in that the yoke (14) is adhesively bonded to the winding legs (11, 12, 13), in particular to the longitudinal ends of the winding legs (11, 12, 13).

13. Magnetic core (10) according to any one of the preceding claims,
characterized in that
a discharge leg, which is connected to the yoke (14), is arranged centrally between the three winding legs (11, 12, 13).

14. Three-phase choke or three-phase transformer having a magnetic core (10) according to any one of the preceding claims and having at least one electrical winding (21, 22, 23), which is wound around one of the winding legs (11, 12, 13).

15. Choke or transformer according to claim 14,
characterized in that
the winding (21, 22, 23) is formed by a flat wire, in particular a flat enamelled copper wire.
